(19) United States
(12) Patent Application Publication
(10) Pub. No.: US 2009/0130358 A1
(43) Pub. Date: May 21, 2009

(54) Water hose and composition for hose

(75) Inventors: Mitsugu Ono, Aichi-ken (JP); Takao Fuma, Aichi-ken (JP); Yasushi Nakahara, Aichi-ken (JP); Hidekazu Kurimoto, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 12/289,223

(22) Filed: Oct. 23, 2008

(30) Foreign Application Priority Data
Nov. 16, 2007 (JP) 2007-298705
Mar. 27, 2008 (JP) 2008-084234

(51) Int. Cl. F16L 11/10; C08L 9/00; F16L 11/20

(52) U.S. Cl. 428/36.91; 138/126; 525/232; 138/137

(57) ABSTRACT

The present invention provides a water hose which includes an inner layer and an outer layer that are concentric and tube-shaped, and a reinforcement fiber layer that is formed by interweaving reinforcement fibers between the inner layer and the outer layer. The inner layer and the outer layer are formed by vulcanizing a composition for a hose that includes an ethylene-propylene-nonconjugated diene copolymer and an ethylene-butene-nonconjugated diene copolymer such that a mass ratio (ethylene-propylene-nonconjugated diene copolymer/ethylene-butene-nonconjugated diene copolymer) is 80/20 to 30/70. A Mooney viscosity (ML (1+4) 100° C.) of the ethylene-butene-nonconjugated diene copolymer is lower than a Mooney viscosity (ML (1+4) 100° C.) of the ethylene-propylene-nonconjugated diene copolymer.

### INCORPORATION BY REFERENCE

The present application claims priority under 35 U.S.C. §119 to Japanese Patent Application Nos. 2007-298705 filed on Nov. 16, 2007 and 2008-084234 filed on Mar. 27, 2008. The contents of these applications are incorporated herein by reference in their entireties.

### TECHNICAL FIELD

The present invention relates to water hoses such as radiator hoses and compositions for hoses that are used in water hoses.

### BACKGROUND OF THE INVENTION

Presently, water hoses such as radiator hoses and heater hoses and the like have an inner layer and an outer layer that are concentric and tube-shaped, and include a reinforcement fiber layer that is formed by interweaving reinforcement fibers, which consist of a polyamide or the like, between the inner layer and the outer layer in order to increase the mechanical strength of the hose. As disclosed in Japanese Patent No. 2577648, in consideration of the water resistance, the heat resistance, and the weather resistance of the hose, the inner layer and the outer layer are formed by vulcanizing a composition for a hose that includes an ethylene-propylene-nonconjugated diene copolymer (EPDM).

In addition, as disclosed in Japanese Patent Application Pubication No. JP-A-H11-311377, in a manufacturing method for a water hose, an inner layer is formed in a tube-shape by using an inner layer extruder, a reinforcement fiber layer is provided by interweaving reinforcement fibers into a spiral shape on the outer periphery of the inner layer by using a spiralling machine, and subsequently an outer layer is formed by using an outer layer extruder so as to cover the reinforcement fibers.

Therefore, when taking into consideration formability (extrudability), preferably the ethylene-propylene-nonconjugated diene copolymer that is used in the inner layer and the outer layer has a low viscosity.

However, when installed in an automobile, a water hose requires a rigidity for preventing closure of the hose due to bending, and pressure resistance so as to be able to resist the pressure of, for example, a coolant liquid that flows through the inside of the hose. Thus, taking into consideration the formability of the inner layer and the outer layer, the wall thickness of the hose has to be made thick.

Note that, while not a rubber (composition) for a hose, Japanese Patent Application Publication No. JP-A-S62-86035 discloses a rubber compound in which a 1,2-polybutadiene having a high melting point (about 140° C. or greater) is mixed in a rubber such as EPDM. However, it is thought that even if this compound is used, the wall thickness of the water hose cannot be made thin.

### SUMMARY OF THE INVENTION

Thus, it is an object of the present invention to provide a water hose formed of a composition for a hose that enables making the wall thickness of the hose thin, and a composition for a hose that enables making the wall thickness of the hose thin.

### A. Water Hose

In order to attain the objects described above, the water hose according to the present invention has an inner layer and an outer layer that are concentric and tube-shaped, and includes a reinforcement fiber layer that is formed by interweaving reinforcement fibers between the inner layer and the outer layer. In the water hose according to the present invention, the inner layer and the outer layer are formed by vulcanizing a composition for a hose that includes an ethylene-propylene-nonconjugated diene copolymer (below, abbreviated “EPDM”) and an ethylene-butene-nonconjugated diene copolymer (below, abbreviated “EBDM”) such that the mass ratio (EPDM/EBDM) is 80/20 to 30/70, and the Mooney viscosity (ML(1+4)100° C.) of the EBDM is lower than the Mooney viscosity (ML(1+4)100° C.) of the EPDM.

Here, the Mooney viscosity (ML(1+4)100° C.) is measured according to JIS K6300, and obtained by using an L-shaped rotor, having a preheating of 1 minute, and rotating the rotor 4 minutes at 100° C. (below, referred to as the “100° C. Mooney viscosity”).

In addition, preferably the mass ratio (EPDM/EBDM) of the EPDM and the EBDM is 70/30 to 50/50, and more preferably, 70/30to 60/40.

In addition, preferably the tensile stress (M10) of the vulcanizate of the composition for a hose, which is used in the water hose described above, at an elongation of 10% is 1.0 to 2.0 MPa, and more preferably, 1.2 to 1.7 MPa.

In the present specification, a tensile stress (M10) at an elongation of 10% is a value that has been measured according to the JIS K6251.

In order to attain the object described above, an alternative water hose according to the present invention has an inner layer and an outer layer that are concentric and tube-shaped, and a reinforcement fiber layer that is formed by interweaving reinforcement fibers between the inner layer and the outer layer. In the water hose, the inner layer and the outer layer are formed by vulcanizing the composition for a hose that is disclosed next.

### B. Composition for a Hose

In order to attain the objects described above, a composition for a hose according to the present invention is a composition for a hose, which is vulcanized for use in an inner layer and an outer layer of a water hose, the water hose having the inner layer and the outer layer, which are concentric and tube-shaped, and including a reinforcement fiber layer that is formed by interweaving reinforcement fibers between the inner layer and the outer layer. The composition for a hose includes an amorphous EPDM, which is a non-crystalline EPDM, and a crystalline polymeric agent that has a melting point of 45 to 105° C. and a heat of fusion of 3 to 40 J/g. The tensile stress of the vulcanizate of the composition for a hose at an elongation of 10% is equal to or greater than 1.0 MPa.

In the present specification, the melting point (Tm) is the temperature at which the crystallinity of the crystalline polymeric agent breaks down and the polymeric agent starts to flow.

In addition, although not limiting in particular, preferably the 100° C. Mooney viscosity is equal to or less than 80 because the water hose is readily formed.

In addition, the Mooney viscosity (ML(1+4)80° C.) (below, referred to as “80° C. Mooney viscosity”) measured according to JIS K6300 and obtained by using an L-shaped rotor, having a preheating of 1 minute, and rotating the rotor 4 minutes at 80° C. is preferably equal to or less than 130, while not limiting in particular.

In addition, although not limiting in particular, preferably the mass ratio (amorphous EPDM/crystalline polymeric agent) of the amorphous EPDM and the crystalline polymeric agent is 80/20 to 30/70.

Each of the essential modes in the present invention is illustrated below.

### 1. Reinforcement Fiber

Although not limiting in particular, in terms of dtex units, a dtex unit being the weight in gram units per 10,000 m length, preferably the thickness of the reinforcement fibers is 940 to 2800. With respect to a hose that has a large inner diameter (equal to or greater than 20 mm), such as a radiator hose, preferably the thickness is 1880 to 2800. With respect to a hose that has a small inner diameter (less than 20 mm), such as a heater hose, preferably the thickness is 940 to 1880.

Although not limiting in particular, examples of materials that are used for the reinforcement fiber include polyamide resins such as polyamide 6, polyamide 11, polyamide 12, polyamide 46, polyamide 66, polyamide 610, polyamide 6T, polyamide 6I, polyamide 9T , and aramide resins and the like, polyester resins such as polyethylene terephthalate, and rayons and the like.

In addition, the reinforcement fiber may be a fiber that consists of one type of material, or may be a fiber that consists of two or more types of material.

In addition, in consideration of the adhesiveness of the inner layer and the outer layer, the reinforcement fiber may be one that has been subject to a surface treatment such as RFL treatment or the like.

### 2. Amorphous EPDM

Although not limiting in particular, the amorphous EPDM, in which the 100° C. Mooney viscosity thereof is higher than the 100° C. Mooney viscosity of the EBDM, can be one that is generally used for water hoses.

In addition, although not limiting in particular, preferably the 100° C. Mooney viscosity is 40 to 200, and more preferably, 80 to 120.

In addition, although not limiting in particular, preferably the incorporated amount of the nonconjugated diene (the amount of the nonconjugated diene component in the EPDM), which is a third component, is 2 to 8 mass %.

In addition, although not limiting in particular, examples of the nonconjugated diene component include 5-ethylidene-2-norbornene (ENB), 1,4-hexadiene (1,4-HD), dicyclopentadiene (DCPD), and preferably the nonconjugated diene component is 5-ethylidene-2-norbornene (ENB).

### 3. Crystalline Polymeric Agent

Although not limited in particular, the crystalline polymeric agent is preferably an EBDM, a 1,2-polybutadiene, or a crystalline EPDM, which is EPDM with crystalline properties.

In addition, the crystalline polymeric agent is crystalline, and thus has a melting point (Tm).

When the melting point (Tm) is less than 45° C., the tensile stress (M10) at an elongation of 10% becomes small. In contrast, when the melting point (TM) exceeds 105° C., the extrusion process becomes difficult. Preferably, the melting point (Tm) is 50 to 103° C.

When the heat of fusion is less than 3 J/g, the portion that is crystallized in the molecules is small, and thus it becomes difficult to increase the strength (in particular, the rigidity) of the composition for a hose. In contrast, when the heat of fusion exceeds 40 J/g, processing becomes difficult. Preferably, the heat of fusion is 5 to 38 J/g.

### 4. EBDM

Although not limiting in particular, an EBDM having a low viscosity readily forms a water hose, and thus preferably the 100° C. Mooney viscosity thereof is lower than the 100° C. Mooney viscosity of the amorphous EPDM.

Although not limiting in particular, preferably the 100° C. Mooney viscosity of the EBDM is 10 to 40, more preferably 10 to 30, and even more preferably, 15 to 25.

In addition, although not limiting in particular, preferably the incorporated amount of the nonconjugated diene (the amount of the nonconjugated diene component in the EBDM), which is a third component, is 2 to 13 mass %.

In addition, although not limiting in particular, examples of a nonconjugated diene component include 5-ethylidene-2-norbornene (ENB), 1,4-hexadiene (1,4-HD), and dicyclopentadiene (DCPD), and preferably the nonconjugated diene component is 5-ethylidene-2-norbornene (ENB).

5. 1,2-polybutadiene

Although not limiting in particular, preferably the 1, 2-polybutadiene has a melting point of 50 to 105° C., and more preferably, 70 to 103° C. Preferably the heat of fusion is 3 to 15 J/g, and more preferably, 5 to 10 J/g.

### 6. Crystalline EPDM

Although not limiting in particular, a crystalline EPDM that has a low viscosity readily forms a water hose, and thus preferably the 100° C. Mooney viscosity thereof is lower than the 100° C. Mooney viscosity of the amorphous EPDM.

Although not limiting in particular, the 100° C. Mooney viscosity is preferably 10 to 40, and more preferably, 15 to 35.

In addition, although not limiting in particular, the incorporated amount of the nonconjugated diene (the amount of the nonconjugated component in the EPDM), which is a third component, is preferably 2 to 10 mass %.

In addition, although not limiting in particular, examples of the nonconjugated diene component include 5-ethylidene-2-norbornene (ENB), 1,4-hexadiene (1,4-HD), dicyclopentadiene (DCPD), and preferably the nonconjugated diene component is 5-ethylidene-2-norbornene (ENB).

### 7. Vulcanization Method

Although not limiting in particular, for the method of vulcanization of the composition for a hose, a method that is generally used in the vulcanization of water hoses may be used, and examples of the method include a method that uses a vulcanizing pan, a method that uses a continuous vulcanizer and the like. The vulcanizing conditions are not limited in particular, but a temperature from 140 to 165° C. and a heating time from 10 to 50 minutes are preferable.

### 8. Vulcanization System Chemicals

The composition for a hose is one that includes vulcanization system chemicals in order to effect vulcanization.

Although not limiting in particular, preferably the added amounts of the vulcanization system chemicals for vulcanizing the composition for a hose is 2 to 6 parts by mass for a total of 100 parts by mass of the amorphous EPDM and the crystalline polymeric agent.

In addition, although not limiting in particular, examples of the vulcanization system chemicals include sulfur, an organic vulcanizing agent, and a vulcanization accelerator and the like. One of the above chemicals may be used singly, or two or more may be used together.

### 8-1. Organic Vulcanizing Agents

Although not limiting in particular, examples of organic vulcanizing agents include p-quinonedioxime, p,p′-dibenzoylquinonedioxime, poly p-dinitrosobenzene, 4,4′-dithiodimorpholine, ammonium benzoate, N,N′-m-phenylenedimaleimide, tetrachloro-benzoquinone, N,N′-bis(2-methyl-2-nitropropyl)-1,6-hexanediamine, alkylphenol formaldehyde resin, brominated alkylphenol formaldehyde resin, and alkylphenolsulfide resin. Additional examples are organic peroxides such as benzoylperoxide, 1,1-bis(t-butylperoxy)-3,3,5-trimethylcyclohexane, n-butyl 4,4-bis(t-butylperoxy)valerate, dicumyl peroxide, t-butylperoxybenzoate, di-t-butylperoxide, α,α′-bis(t-butylperoxy)diisopropyl benzene, 2,5-dimethyl-2,5-bis(t-butylperoxy)hexane, 2,5-dimethyl-2,5-bis(t-butylperoxy)hexine-3, and t-butylperoxycumene.

### 8-2 Vulcanization Accelerators

Although not limiting in particular, examples of vulcanization accelerators include thiazole compounds, dithiocarbamate compounds, sulfenamide compounds, and thiuram compounds.

### 8-2-1 Thiazole Compounds

Although not limiting in particular, examples of thiazole compounds include 2-mercaptobenzothiazole, dibenzothiazyl disulfide, zinc salt of 2-mercaptobenzothiazole, cyclohexylamine salt of 2-mercaptobenzothiazole, 2-(N,N′-diethylthiocarbamoylthio)benzothiazole, and 2-(4′-morpholinodithio)benzothiazole.

### 8-2-2 Dithiocarbamate Compounds

Although not limiting in particular, examples of dithiocarbamate compounds include piperidinium pentamethylenedithiocarbamate, pipecolin pipecolyldithiocarbamate, zinc dimethyldithiocarbamate, zinc diethyldithiocarbamate, zinc dibutyldithiocarbamate, zinc N-ethyl-N-phenyldithiocarbamate, zinc N-pentamethylenedithiocarbamate, zinc dibenzyldithiocarbamate, sodium dimethyldithiocarbamate, sodium diethyldithiocarbamate, sodium dibutyldithiocarbamate, copper dimethyldithiocarbamate, ferric dimethyldithiocarbamate, and tellurium diethyldithiocarbamate.

### 8-2-3 Sulfenamide Compounds

Although not limiting in particular, examples of sulfenamide compounds include N-cyclohexyl-2-benzothiazolyl-sulfenamide, N-tert-butyl-2-benzothiazolyl-sulfenamide, N-oxydiethylene-2-benzothiazolyl-sulfenamide, and N, N′-dicyclohexyl-2-benzothiazolyl-sulfenamide.

### 8-2-4 Thiuram Compounds

Although not limiting in particular, examples of thiuram compounds include tetramethylthiuram disulfide, tetraethylthiuram disulfide, tetrabutylthiuram disulfide, tetrakis(2-ethylhexyl)thiuram disulfide, tetramethylthiuram monosulfide, and dipentamethylenethiuram tetrasulfide.

### 9. Other Additives

In order to increase the performance of the water hose, additives such as fillers, softeners and the like may be added to the composition for a hose, or alternatively, no additives maybe used.

### 10. Ratio of Thickness of Inner Layer to Outer Layer

The ratio of the thickness of the inner layer to the outer layer is not limited in particular, but preferably the inner layer/outer layer is 40/60 to 70/30.

### 11. Use of Water Hose

Although not limiting in particular, with respect to the use of a water hose through which flows a liquid whose main component is water, such as the cooling water for the engine, a narrow water hose having an inner diameter of less than 20 mm is preferably used for a heater hose that connects the engine and a heating unit, and a thick water hose having an inner diameter of 20 mm or more (more preferably, 25 mm or more) is preferably used for a radiator hose that links the radiator and the engine.

According to the present invention, it is possible to provide a water hose formed of a composition for a hose that enables making the wall thickness of the hose thin and a composition for a hose that enables making the wall thickness of the hose thin.

### BRIEF DESCRIPTION OF THE DRAWINGS

FIG. 1 is a perspective view of a water hose according to an example of the present invention;

FIG. 2 is a graph that shows the relationship between the 100° C. Mooney viscosity and M10;

FIG. 3 is a graph that shows the relationship between the 80° C. Mooney viscosity and M10; and

FIG. 4 is a graph that shows the change over time in the amount of reduction of the thickness.

### DETAILED DESCRIPTION OF THE INVENTION

A composition for a hose according to the present invention is a composition for a hose, which is vulcanized for use in an inner layer and an outer layer of a water hose, the water hose having the inner layer and the outer layer, which are concentric and tube-shaped, and including a reinforcement fiber layer that is formed by interweaving reinforcement fibers between the inner layer and the outer layer. The composition for a hose includes an amorphous EPDM which is a non-crystalline EPDM, and a crystalline polymeric agent that has a melting point of 45 to 105° C. and a heat of fusion of 3 to 40 J/g such that the mass ratio (amorphous EPDM/crystalline polymeric agent) is 80/20 to 30/70, the 100° C. Mooney viscosity is equal to or less than 80, and the tensile stress of the vulcanizate at an elongation of 10% is equal to or greater than 1.0 MPa.

A water hose according to the present invention has an inner layer and an outer layer that are concentric and tube-shaped, and includes a reinforcement fiber layer that is formed by interweaving reinforcement fibers between the inner layer and the outer layer.

In the water hose, the inner layer and the outer layer are formed by vulcanizing a composition for a hose that includes an amorphous EPDM, which is a non-crystalline EPDM, and a crystalline polymeric agent that has a melting point of 45 to 105° C. and a heat of fusion of 3 to 40 J/g such that the mass ratio (amorphous EPDM/crystalline polymeric agent) is 80/20 to 30/70, the 100° C. Mooney viscosity is equal to or less than 80, and the tensile stress of the vulcanizate at an elongation of 10% is equal to or greater than 1.0 MPa.

### EXAMPLES

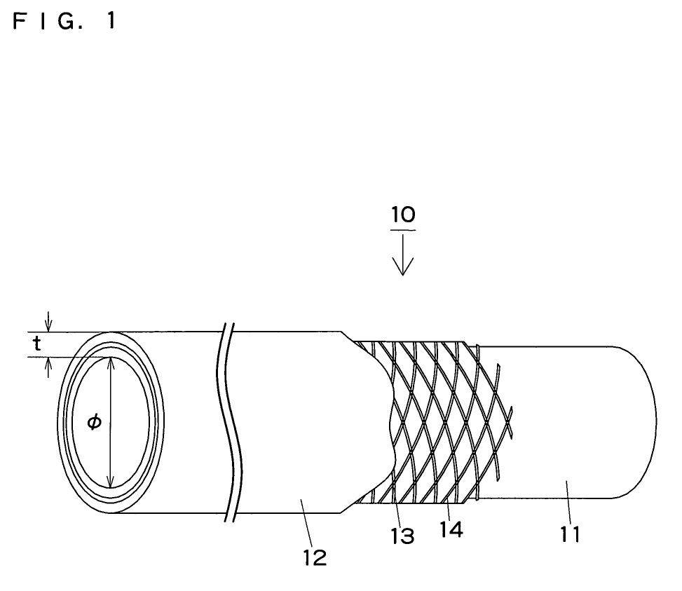

As shown in FIG. 1, a water hose 10 of the present invention has an inner layer 11 and an outer layer 12 that are concentric and tube-shaped, and includes a reinforcement fiber layer 14 that is formed by interweaving reinforcement fibers 13 consisting of polyamide 66 (nylon 66) between the inner layer 11 and the outer layer 12.

In addition, the composition for a hose of the present invention is vulcanized to form the inner layer 11 and the outer layer 12.

The preparation of the examples (14 types) of the composition for a hose of the present invention and the comparative examples (4 types) and the measurement results of the physical properties and the like are shown in the following TABLES 1 and 2.

Note that the unit in the preparation column is parts by mass.

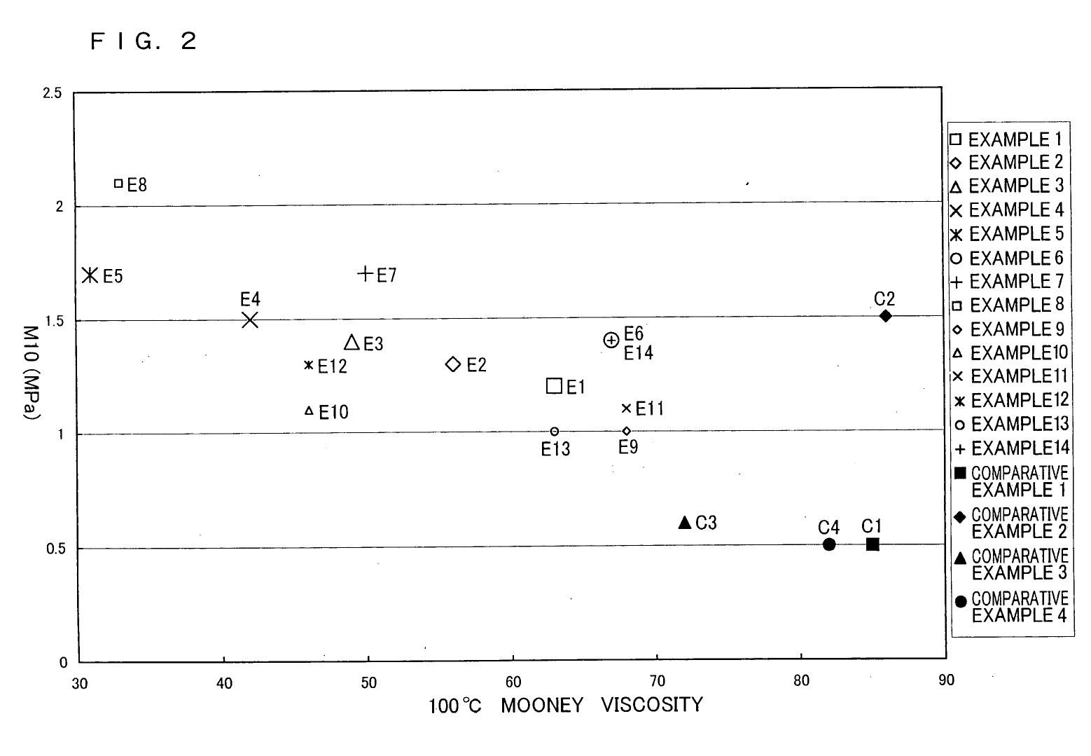

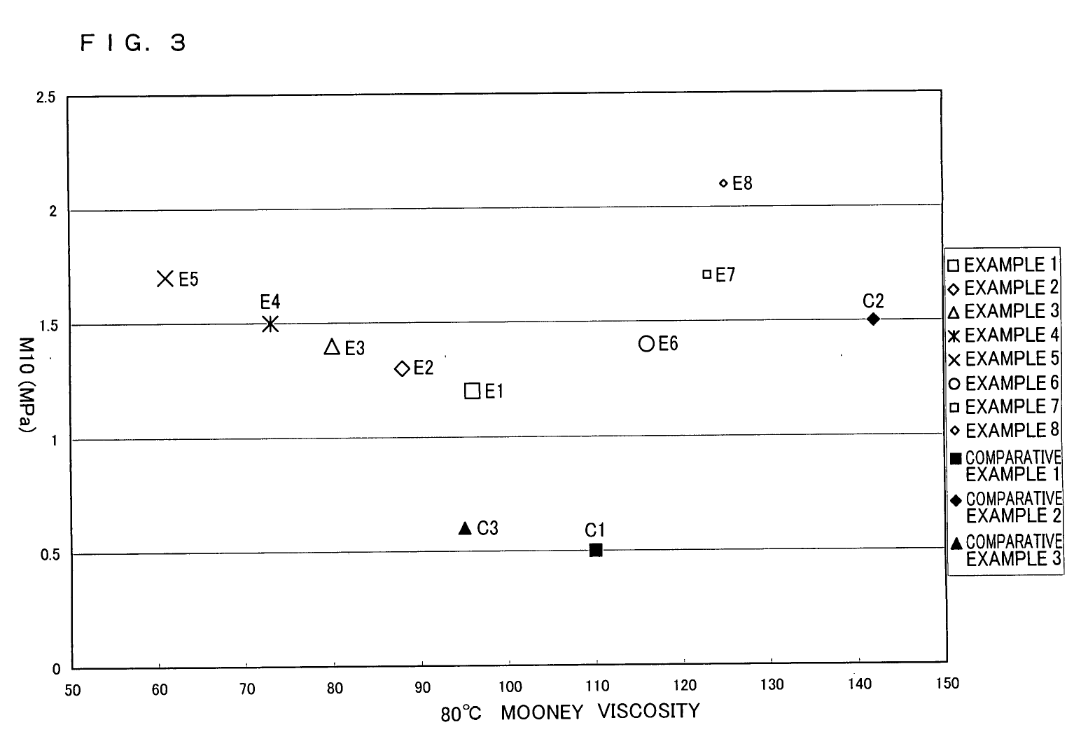

In addition, a graph of the relationship between the tensile stress (M10) at an elongation of 10%, the 100° C. Mooney viscosity, and the 80° C. Mooney viscosity of each of the samples are shown in FIG. 2 (100° C. Mooney viscosity) and FIG. 3 (80° C. Mooney viscosity).

TABLE 1

| | | | | | | | | | | Compar- | Compar- | Compar- |
|---|---|---|---|---|---|---|---|---|---|---|---|---|
| | | Exam- | Exam- | Exam- | Exam- | Exam- | Exam- | Exam- | Exam- | ative | ative | ative |
| | | ple 1 | ple 2 | ple 3 | ple 4 | ple 5 | ple 6 | ple 7 | ple 8 | Example 1 | Example 2 | Example 3 |
| Preparation Name | | A1 | A2 | A3 | A4 | A5 | E1 | E2 | E3 | B1 | B2 | B3 |
| Material | EPDM1 | 80.00 | 70.00 | 60.00 | 50.00 | 30.00 | 80.00 | 60.00 | 30.00 | 100.00 | | 60.00 |
| Name & | EBDM | 20.00 | 30.00 | 40.00 | 50.00 | 70.00 | | | | | | |
| Preparation | EPDM2 | | | | | | 20.00 | 40.00 | 70.00 | | | |
| | EPDM3 | | | | | | | | | | 100.00 | 40.00 |
| | Carbon Black | 85.00 | 85.00 | 85.00 | 85.00 | 85.00 | 85.00 | 85.00 | 85.00 | 90.00 | 60.00 | 85.00 |
| | Process Oil | 40.00 | 40.00 | 40.00 | 40.00 | 40.00 | 40.00 | 40.00 | 40.00 | 70.00 | | 40.00 |
| | Clay | 70.00 | 70.00 | 70.00 | 70.00 | 70.00 | 70.00 | 70.00 | 70.00 | 40.00 | | 70.00 |
| | Zinc Oxide | 5.00 | 5.00 | 5.00 | 5.00 | 5.00 | 5.00 | 5.00 | 5.00 | 5.00 | 5.00 | 5.00 |
| | Stearic Acid | 1.00 | 1.00 | 1.00 | 1.00 | 1.00 | 1.00 | 1.00 | 1.00 | 1.00 | 1.00 | 1.00 |
| | Vulcanization | 4.50 | 4.50 | 4.50 | 4.50 | 4.50 | 4.50 | 4.50 | 4.50 | 4.50 | 4.50 | 4.50 |
| | System | | | | | | | | | | | |
| | Chemical | | | | | | | | | | | |
| | | 305.5 | 305.5 | 305.5 | 305.5 | 305.5 | 305.5 | 305.5 | 305.5 | 310.5 | 170.5 | 305.5 |
| Unvulcanized | Mooney | 96 | 88 | 80 | 73 | 61 | 116 | 123 | 125 | 110 | 142 | 95 |
| Property | viscosity | | | | | | | | | | | |
| | (@80° C.) | | | | | | | | | | | |
| | ML1 + 4 (M) | | | | | | | | | | | |
| | Mooney | 63 | 56 | 49 | 42 | 31 | 67 | 50 | 33 | 85 | 86 | 72 |
| | viscosity | | | | | | | | | | | |
| | (@100° C.) | | | | | | | | | | | |
| | ML1 + 4 (M) | | | | | | | | | | | |
| Normal | TB (Mpa) | 11.3 | 10.9 | 10.9 | 10.4 | 10.1 | 11.4 | 11.5 | 12.0 | 11.5 | 15.1 | 10.9 |
| Physical | EB (%) | 450 | 420 | 410 | 470 | 430 | 460 | 460 | 420 | 490 | 320 | 420 |
| Property | M10 (Mpa) | 1.2 | 1.3 | 1.4 | 1.5 | 1.7 | 1.4 | 1.7 | 2.1 | 0.5 | 1.5 | 0.6 |
| (160° C. × 15 min) | HS (type A) | 76 | 78 | 78 | 80 | 83 | 82 | 85 | 87 | 61 | 82 | 70 |

| | | | | | | | | | | | |
|---|---|---|---|---|---|---|---|---|---|---|---|
| Extrudability | ◯ | ◯ | ◯ | ◯ | ◯ | ◯ | ◯ | ◯ | ◯ | X | ◯ |
| Overall Evaluation | ◯ | ◯ | ◯ | ◯ | ◯ | ◯ | ◯ | ◯ | X | X | X |

TABLE 2

| | | | | Example | Example | | | Comparative | Comparative |
|---|---|---|---|---|---|---|---|---|---|
| | | Example 9 | Example 10 | 11 | 12 | Example 13 | Example 14 | Example 1 | Example 4 |
| Preparation Name | | C1 | C2 | C3 | C4 | C5 | C6 | B1 | D2 |
| Material Name & | EPDM 1 | 80.00 | 60.00 | 80.00 | 60.00 | 80.00 | 60.00 | 100.00 | 60.00 |
| Preparation | 1,2-Polybutadiene 1 | 20.00 | 40.00 | | | | | | |
| | 1,2-Polybutadiene 2 | | | 20.00 | 40.00 | | | | |
| | 1,2-Polybutadiene 3 | | | | | 20.00 | 40.00 | | |
| | 1,4-Polybutadiene | | | | | | | | 40.00 |
| | Carbon Black | 85.00 | 85.00 | 85.00 | 85.00 | 85.00 | 85.00 | 90.00 | 85.00 |
| | Process Oil | 40.00 | 40.00 | 40.00 | 40.00 | 40.00 | 40.00 | 70.00 | 40.00 |
| | Clay | 70.00 | 70.00 | 70.00 | 70.00 | 70.00 | 70.00 | 40.00 | 70.00 |
| | Zinc Oxide | 5.00 | 5.00 | 5.00 | 5.00 | 5.00 | 5.00 | 5.00 | 5.00 |
| | Stearic Acid | 1.00 | 1.00 | 1.00 | 1.00 | 1.00 | 1.00 | 1.00 | 1.00 |
| | Vulcanization | 4.50 | 4.50 | 4.50 | 4.50 | 4.50 | 4.50 | 4.50 | 4.50 |
| | System Chemical | | | | | | | | |
| | | 305.5 | 305.5 | 305.5 | 305.5 | 305.5 | 305.5 | 310.5 | 305.5 |
| Unvulcanized | Mooney viscosity | 68 | 46 | 68 | 46 | 63 | 67 | 85 | 82 |
| Property | (@100° C.) | | | | | | | | |
| | ML1 + 4 (M) | | | | | | | | |
| Normal Physical | TB (Mpa) | 9.0 | 7.2 | 9.2 | 7.2 | 8.0 | 7.5 | 11.5 | 10.9 |
| Property | EB (%) | 460 | 390 | 460 | 360 | 450 | 360 | 490 | 380 |
| (160° C. × 15 min) | M10 (Mpa) | 1.0 | 1.1 | 1.1 | 1.3 | 1.0 | 1.4 | 0.5 | 0.5 |
| | HS (type A) | 73 | 76 | 76 | 80 | 75 | 81 | 61 | 61 |

| | | | | | | | | |
|---|---|---|---|---|---|---|---|---|
| Extrudability | ◯ | ◯ | ◯ | ◯ | ◯ | ◯ | ◯ | X |
| Overall Evaluation | ◯ | ◯ | ◯ | ◯ | ◯ | ◯ | X | X |

The three types of ethylene propylene nonconjugated diene copolymer (EPDM), the one type of EBDM, the three types of 1,2-polybutadiene, and the one type of 1,4-polybutadiene that were used in the present examples and the comparative examples are as follows.

An EPDM 1 was an ethylene-propylene-nonconjugated diene copolymer (amorphous EPDM) that is non-crystalline, had a 100° C. Mooney viscosity of 100, the nonconjugated diene component thereof, which is a third component, was 5-ethylidene-2-norbornene (ENB), and the incorporated amount thereof was 4.5 mass %.

An EPDM 2 was an ethylene-propylene-nonconjugated diene copolymer (crystalline EPDM) that had a melting point of 95° C., had a heat of fusion of 38 J/g (mJ/mg) as measured by a differential scanning calorimeter (DSC), had a 100° C. Mooney viscosity of 32, the nonconjugated diene component thereof, which is a third component, was 5-ethylidene-2-norbornene (ENB), and the incorporated amount thereof was 4.5 mass %.

An EPDM 3 was an ethylene-propylene-nonconjugated diene copolymer (amorphous EPDM) that is non-crystalline, had a 100° C. Mooney viscosity of 45, the nonconjugated diene component thereof, which is a third component, was 5-ethylidene-2-norbornene (ENB), and the incorporated amount thereof was 8.1 mass %.

The EBDM had a melting point of 50° C., had a heat of fusion of 34 J/g (mJ/mg) as measured by the differential scanning calorimeter (DSC), had a 100° C. Mooney viscosity of 20, the nonconjugated diene component thereof, which is a third component, was 5-ethylidene-2-norbornene (ENB), and the incorporated amount thereof was 10.5 mass %.

A 1,2-polybutadiene 1 had a melting point of 71° C., and had a heat of fusion, as measured by the differential scanning calorimeter (DSC), of 5 J/g (mJ/mg).

A 1,2-polybutadiene 2 had a melting point of 95° C., and had a heat of fusion, as measured by the differential scanning calorimeter (DSC), of 10 J/g (mJ/mg).

A 1,2-polybutadiene 3 had a melting point of 103° C., and had a heat of fusion, as measured by the differential scanning calorimeter (DSC), of 5 J/g (mJ/mg).

The 1,4-polybutadiene was non-crystalline, and had a 100° C. Mooney viscosity of 44.

The physical properties of the compositions for a hose in TABLES 1 and 2 were measured as follows.

### (1) Mooney Viscosity (ML(1+4)80° C.), (ML(1+4)100° C.)

The measurement was carried out according to JIS K6300, in which an L-shaped rotor was used, preheating was carried out for 1 minute at test temperatures of 80° C. and 100° C., and the rotation time of the rotor was 4 minutes.

### (2) Normal Physical Property

The tensile strength (TB), the elongation at break (EB), the tensile stress (M10) at an elongation of 10%, and hardness (HS) of test pieces that were vulcanized at 160° C. for 15 minutes were each measured.

The tensile strength (TB), the elongation at break (EB), and the tensile stress (M10) at an elongation of 10% were each measured according to JIS K6251.

The hardness (HS) was measured according to JIS K6253, and the measurement was carried out by using a type A durometer.

### (3) Extrudability

An evaluation of satisfactory or defective extrudability was carried out by using the pressure during extrusion by using an extruder.
O: satisfactory
X: defective

The evaluations of each of the samples (compositions for a hose) were carried out based on the measurement results of the above physical properties.
O: satisfactory
X: defective

As shown in FIGS. 2 and 3, in comparison to the comparative examples, all of the examples (14 types) tended to have a Mooney viscosity that was relatively low and a tensile stress (M10) at an elongation of 10% that was relatively high. Therefore, in particular because the 100° C. Mooney viscosity was low (equal to or less than 68), the extrudability was satisfactory and the tensile stress (M10) at an elongation of 10% was also high (equal to or greater than 1 MPa), and thus the overall evaluations were satisfactory.

According to the composition for a hose of the present invention, because the viscosity during processing (80 to 100° C.) was low and the rigidity (the tensile stress at an elongation of 10%) of the vulcanizate was high, it was possible to make the wall thickness of the water hose thin.

Next, the structures and the measurement results of the performance of the examples 1a to 4a of the water hose according to the present invention and the comparative examples 1b to 3b are shown in the following TABLE 3.

Among the examples of the present invention, the example 2 (preparation name: A2) and the example 3 (preparation name: A3) of the composition for a hose were used, and the comparative example 1 (preparation name: B1) of the composition for a hose was used for the comparative examples.

Note that the wall thickness ratio (t/φ) in the TABLE 3 is the value of the hose wall thickness (t) divided by the hose inner diameter (φ).

TABLE 3

| | | | | Hose Structure, Dimensions | | | | Characteristic, Performance | | |
|---|---|---|---|---|---|---|---|---|---|---|
| | | | | | | | Thickness of | | | Amount of |
| | | | | Hose Inner | Hose Wall | Wall | Reinforcement | | | Reduction |
| | Composition For Hose | | | Diameter | Thickness | Thickness | Fibers | Bursting | Compression | in Thickness |
| | Preparation | EPDM/ | M10 | (φ) | (t) | Ratio | Nylon 66 | Pressure | Load | 120° C. × 120 h |
| | Name | EBDM | (MPa) | (mm) | (mm) | (t/φ) | (dtex) | (Mpa) | (N) | (mm) |
| Example 1a | A2 | 70/30 | 1.3 | 30 | 2.5 | 0.083 | 1880 | 1.98 | 5 | 0.10 |
| | | | | | | | | | | (clip A) |
| Example 2a | A3 | 60/40 | 1.4 | 30 | 2.5 | 0.083 | 1880 | 2.04 | 5.7 | 0.07 |
| | | | | | | | | | | (clip A) |
| Example 3a | ↑ | ↑ | ↑ | 37 | 3.1 | 0.084 | 1880 | 1.6 | 7 | — |
| Example 4a | ↑ | ↑ | ↑ | 37 | 3.5 | 0.095 | 1880 | 1.68 | 7.8 | — |
| Comparative | B1 | 100/0 | 0.5 | 30 | 4.0 | 0.133 | 2800 | 2.29 | 6.1 | 0.15 |
| Example 1b | | | | | | | | | | (clip B) |
| Comparative | ↑ | ↑ | ↑ | 37 | 5.0 | 0.135 | 2800 | 1.84 | 6.3 | — |
| Example 2b | | | | | | | | | | |
| Comparative | ↑ | ↑ | ↑ | 30 | 2.5 | 0.083 | 1880 | 1.88 | 2.2 | 0.12 |
| Example 3b | | | | | | | | | | (clip A) |

The respective samples (water hoses) of the examples and the comparative examples were produced by forming an inner layer into a tube-shape by using an inner layer extruder, providing a reinforcement fiber layer, which is formed by interweaving reinforcement fibers in a spiral shape on the outer periphery thereof by using a spiraling machine, and then forming the outer layer by using an outer layer extruder so as to cover the reinforcement fibers. Subsequently, heating was carried out for 25 minutes at 150° C. to vulcanize the compositions for a hose that were used in the inner layer and the outer layer.

The performance tests for each of the water hoses were carried out as follows.

### (a) Bursting Pressure

At room temperature, after fastening one end of a water hose that is a sample to a compression tester by using a hose clamp, the inside of the sample (the inside of the hose) was filled with an engine coolant liquid. Subsequently, the other end was closed, the pressure was raised at a constant rate (1.98 MPa/min), and the pressure when the sample burst was found.

### (b) Compression Load

Each sample (water hose) having a length of 25 mm was compressed at a constant rate (30 mm/min) in the radial direction thereof, and the load when compressed 10 mm in the radial direction was found.

### (c) Amount of Reduction in Thickness (Deterioration)

Each sample was fitted over the exterior of a pipe, which is the mating part, and clamped by using a flat spring clip on the outer periphery. In this state, in an atmosphere of 120° C., the samples were left standing for 120 hours, and the amount of reduction in the wall thickness was found by using the thickness after passage of 0.67 hours as a reference (0 mm). Note that the amount of reduction in the thickness is an amount that was found by measuring the outer diameter of the flat clip on the outer periphery before and after the test and then halving the difference between these values.

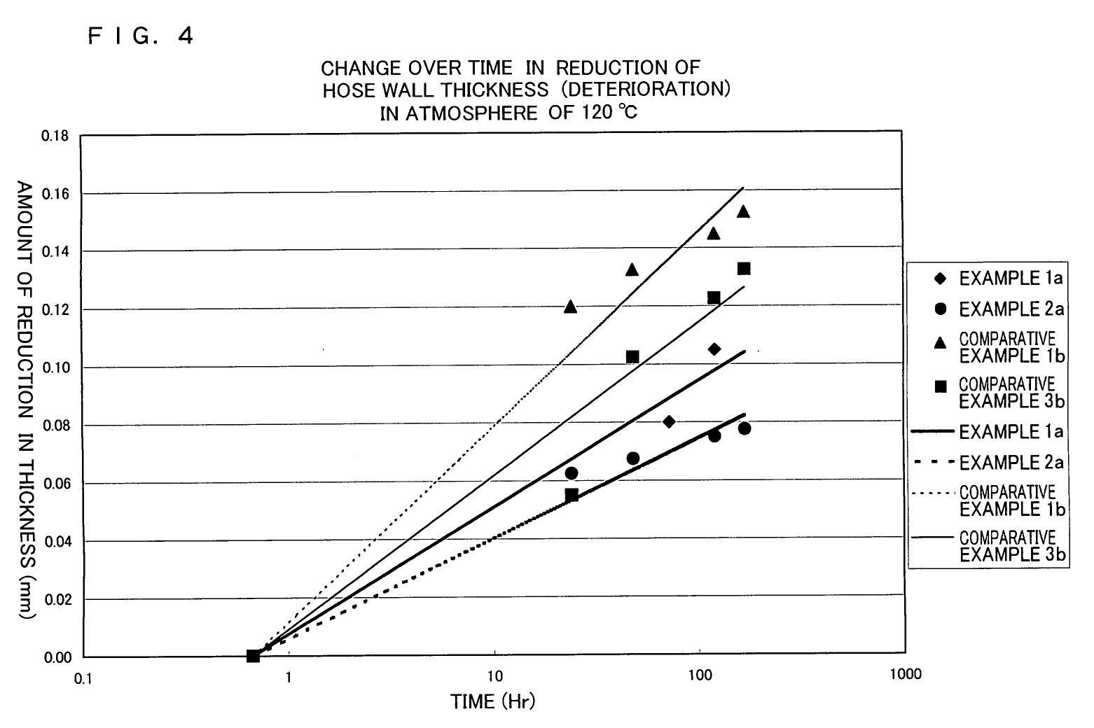

In addition, the change over time in the amount of reduction in the thickness of each sample is shown in FIG. 4.

In the comparative example 3b, in which the inner diameter of the hose is 30 mm, the wall thickness of the hose was made thinner (4 mm→2.5 mm) than that of the comparative example 1b, in which the inner diameter of the hose was identical, and the reinforcement fibers were made narrower (2800 dtex→1880 dtex). As a result, the compression load, which is the index of the rigidity for preventing closure of the hose due to bending during assembly, was reduced.

In the examples 1a and 2a, in which the inner diameter of the hose was 30 mm, although the wall thickness of the hose was made more than 30% thinner (4 mm→2.5 mm) than that of the comparative example 1b, in which the inner diameter of the hose was identical, and the reinforcement fibers were made narrower (2800 dtex→1880 dtex), it was possible to ensure the bursting pressure and the compression load that are necessary for the water hose. In addition, the amount of the reduction in the thickness became small, and in comparison to the comparative example 1b, the deterioration resistance was increased.

The examples 1a and 2a, in which the inner diameter of the hose was 30 mm, had a superior bursting pressure, compression load, and deterioration resistance compared to the comparative example 3b, in which the wall thickness of the hose (2.5 mm) and the thickness of the reinforcement fibers (1880 dtex) were identical to those of the examples 1a and 2a.

In the examples 3a and 4a, in which the inner diameter of the hose was 37 mm, although the wall thickness of the hose was made more than 30% thinner (5 mm→3.5 to 3.1 mm) than that of the comparative example 2b, in which the inner diameter of the hose is identical to that of the examples 3a and 4a, and the reinforcement fibers were made narrower (2800 dtex→1880 dtex), the compression load of the examples 3a and 4a increased more than that of the comparative example 2b.

From the above results, according to the present invention, by making the wall thickness of the hose thin while ensuring the bursting pressure and the compression load that are required in a water hose, it is possible to realize weight and cost reductions of the water hose.

In addition, because the deterioration resistance is improved, it is possible to suppress a reduction in sealing properties due to deterioration over time.

Note that the present invention is not limited by the examples described above, and various suitable modifications may be made without departing from the scope of the invention.

What is claimed is:

1. A water hose comprising:
an inner layer and an outer layer that are concentric and tube-shaped; and
a reinforcement fiber layer that is formed by interweaving reinforcement fibers between the inner layer and the outer layer, wherein
the inner layer and the outer layer comprise a vulcanizate obtained by vulcanizing a composition for a hose that comprises an ethylene-propylene-nonconjugated diene copolymer and an ethylene-butene-nonconjugated diene copolymer such that a mass ratio (ethylene-propylene-nonconjugated diene copolymer/ethylene-butene-nonconjugated diene copolymer) is 80/20 to 30/70; and
a Mooney viscosity (ML(1+4)100° C.) of the ethylene-butene-nonconjugated diene copolymer is lower than a Mooney viscosity (ML(1+4)100° C.) of the ethylene-propylene-nonconjugated diene copolymer.

2. The water hose according to claim 1, wherein the mass ratio (ethylene-propylene-nonconjugated diene copolymer/ethylene-butene-nonconjugated diene copolymer) is 70/30 to 60/40.

3. The water hose according to claim 1, wherein a tensile stress of the vulcanizate of the composition for a hose at an elongation of 10% is 1.0 to 2.0 MPa.

4. A composition for a hose, which is vulcanized for use in an inner layer and an outer layer of a water hose, the water hose having the inner layer and the outer layer that are concentric and tube-shaped and a reinforcement fiber layer that is formed by interweaving reinforcement fibers between the inner layer and the outer layer, the composition for a hose comprising:
an amorphous EPDM that is a non-crystalline ethylene-propylene-nonconjugated diene copolymer; and
a crystalline polymeric agent that has a melting point of 45 to 105° C. and has a heat of fusion of 3 to 40 J/g, wherein a tensile stress of a vulcanizate obtained by vulcanizing the composition for a hose at an elongation of 10% is equal to or greater than 1.0 MPa.

5. The composition for a hose according to claim 4, wherein a Mooney viscosity (ML(1+4)100° C.) is equal to or less than 80.

6. The composition for a hose according to claim 4, wherein a mass ratio (amorphous EPDM/crystalline polymeric agent) of the amorphous EPDM and the crystalline polymeric agent is 80/20 to 30/70.

7. The composition for a hose according to claim 4, wherein the crystalline polymeric agent is one of an ethylene-butene-nonconjugated diene copolymer, a 1,2-polybutadiene, and a crystalline EPDM which is a crystalline ethylene-propylene-nonconjugated diene copolymer.

8. A water hose comprising:
an inner layer and an outer layer that are concentric and tube-shaped; and
a reinforcement fiber layer that is formed by interweaving reinforcement fibers between the inner layer and the outer layer, wherein
the inner layer and the outer layer are formed by vulcanizing the composition for a hose according to claim 4.

9. The water hose according to claim 2, wherein a tensile stress of the vulcanizate of the composition for a hose at an elongation of 10% is 1.0 to 2.0 MPa.

10. The composition for a hose according to claim 5, wherein a mass ratio (amorphous EPDM/crystalline polymeric agent) of the amorphous EPDM and the crystalline polymeric agent is 80/20 to 30/70.

11. The composition for a hose according to claim 5, wherein the crystalline polymeric agent is one of an ethylene-butene-nonconjugated diene copolymer, a 1,2-polybutadiene, and a crystalline EPDM which is a crystalline ethylene-propylene-nonconjugated diene copolymer.

12. The composition for a hose according to claim 6, wherein the crystalline polymeric agent is one of an ethylene-butene-nonconjugated diene copolymer, a 1,2-polybutadiene, and a crystalline EPDM which is a crystalline ethylene-propylene-nonconjugated diene copolymer.

13. The water hose according to claim 8, where in a Mooney viscosity (ML(1+4)100° C.) of the composition for a hose is equal to or less than 80.

14. The water hose according to claim 8, wherein a mass ratio (amorphous EPDM/crystalline polymeric agent) of the amorphous EPDM and the crystalline polymeric agent of the composition for a hose is 80/20 to 30/70.

15. The water hose according to claim 8, wherein the crystalline polymeric agent of the composition for a hose is one of an ethylene-butene-nonconjugated diene copolymer, a 1,2-polybutadiene, and a crystalline EPDM which is a crystalline ethylene-propylene-nonconjugated diene copolymer.
